(19) United States
(12) Patent Application Publication
(10) Pub. No.: US 2016/0092037 A1
(43) Pub. Date: Mar. 31, 2016

(54) Computer-Implemented Methods, Computer Readable Media, And Systems For Distributed Processing

(71) Applicant: OSIX Corporation, Redwood City, CA (US)

(72) Inventors: Adrian Cesena, Palo Alto, CA (US); Amir Ghazvinian, San Francisco, CA (US)

(21) Appl. No.: 14/862,610

(22) Filed: Sep. 23, 2015

Related U.S. Application Data
(60) Provisional application No. 62/055,507, filed on Sep. 25, 2014.
(60) Provisional application No. 62/063,668, filed on Oct. 14, 2014.

(51) Int. Cl. G06F 3/0481; H04L 29/06

(52) U.S. Cl. CPC G06F 3/0481; H04L 65/60; H04L 67/42

(57) ABSTRACT

A server system receives requests for content from a computing device, retrieves the content, and renders the content in a virtual client, e.g. virtual browser, and transmits the rendering to the computing device. The capabilities of the computing device are evaluated. Some content, such as video content may be transmitted directly to the computing device rather than rendered in the virtual client. The capabilities of the computing device may include processing speed and available bandwidth. Content may also be reformatted by the server system before transmitting to the computing device. Co-use, e.g. co-browsing, of the content may be performed by transmitting images of a virtual screen of the virtual client to multiple computing devices and processing inputs from the multiple computing devices in the virtual client.

### RELATED APPLICATIONS

This application claims the benefit of U.S. Provisional Application Ser. No. 62/055,507 filed Sep. 25, 2014, and entitled “Computer-Implemented Methods, Computer Readable Media, And Systems,” which is hereby incorporated herein by reference in its entirety.

This application claims the benefit of U.S. Provisional Application Ser. No. 62/063,668 filed Oct. 14, 2014, and entitled “Computer-Implemented Methods, Computer Readable Media, And Systems,” which is hereby incorporated herein by reference in its entirety.

### FIELD OF THE INVENTION

The present invention is related to the field of computing, and more specifically to techniques for initiating the use of applications over a network.

### BACKGROUND

The Internet has become an essential medium for business and media. Although use of the Internet in modern society is essentially ubiquitous, one potential area of future expansion in the Internet is the ability for users to share online experiences. Sharing online experiences, such as visiting websites, is one way for users to have a social experience on the Internet. These shared online experiences often take the form of co-browsing. In general, co-browsing is joint navigation of websites by multiple people that access web pages at the same time. Some current techniques for co-browsing require special software at the client and/or co-browsing enabled websites. Since users may only co-browse on web sites that are co-browsing enabled, this technology limits the users to only a small subset of Internet sites. As a consequence, it is desirable to create a co-browsing system that does not require special plug-ins or co-browsing enabled websites so as to permit users to co-browse at any website.

### SUMMARY OF THE INVENTION

In one aspect of the invention, a computer-implemented method for distributed computing includes instantiating, on a first computer device comprising at least one processor and memory, an application program. A second computer device for communications with the first computer device is coupled to the first computer device by a network. The method further includes determining, by the application program, a first set of capabilities of the first computer device and a second set of capabilities of the second computer device; receiving a request from the second computer device by the application program, wherein a plurality of options exist for fulfilling an element of the request; determining whether a first option fulfills the element of the request better than a second option based on the first and second sets of capabilities; and directing, by the application program, that the element of the request be fulfilled by the better option.

In some embodiments, the first computer device comprises a first server. A second server is connected to the first server and to the second computer device via the network. The request comprises a request to view a video stored on the second server, wherein the element of the request comprises streaming the video from the second server, wherein the first option comprises streaming the video directly to the second computer device via the network, wherein the second option comprises streaming the video to a virtual browser instantiated on the first server and streaming the video from the virtual browser to the second computer, and wherein the application program directs that the element of the request be fulfilled by the first option.

In some embodiments, the application program contains instructions to direct, when the element of the request comprises streaming the video from the second server, that the video be streamed directly to the second computer.

In another aspect of the invention, a computer implemented method may include:

receiving, by a server system from a first computing device, a request for requested content from a remote server;

retrieving, by the server system, the requested content from the remote server;

rendering, by the server system, an image in a virtual client by processing the requested content;

transmitting, by the server system, the image to the first computing device;

detecting, by the server system, an attempt to access video content referenced in the requested content;

determining, by the server system, that the first computing device is capable of processing the video content; and

in response to determining that the first computing device is capable of processing the video content, invoking streaming of the video content to the first computing device without rendering the video content in the virtual client.

In some embodiments, the virtual client is a web browser and the requested content is a webpage. In some embodiments, determining that the first computing device is capable of processing the video content comprises determining that the video content has a file type that the first computing device is capable of processing. In some embodiments, determining that the first computing device is capable of processing the video content includes determining that the first computing device has sufficient memory and processing speed to process the video content. In some embodiments, determining that the first computing device is capable of processing the video content includes determining that a network connection to the first computing device has sufficient bandwidth to receive the video content. In some embodiments, determining that the first computing device is capable of processing the video content comprises determining that an operating system of the first computing device indicates capacity to process the video content.

In some embodiments, determining that the first computing device is capable of processing the video content comprises determining that the first computing device is hosting an application programmed to interoperate with the virtual client. The computer implemented method may further include (1) formatting the video content for rendering by the application at least one of (a) using a codec of the application and (b) superimposed over a portion of the image such that other interface elements of the requested content are visible on the first computing device while the video content is displayed.

In some embodiments, invoking streaming of the video content to the first computing device without rendering the video content in the virtual client comprises transmitting an instruction to superimpose display of the video content over the image on the first computing device.

In some embodiments, the attempt to access the video content is intercepted from the virtual client. In some embodiments, the attempt to access the video content is intercepted from the first computing device.

In some embodiments, in response to determining that a computing device is not capable of processing the video content, the video content is reformatted into reformatted video content and transmitting the reformatted video content to the second computing device.

In some embodiments, in response to determining that a computing device is not capable of processing the video content, the video content is rendered in the virtual client the rendering of the video is transmitted to the second computing device.

In another aspect of the invention, a system includes one or more processors and one or more memory devices coupled to the one or more processors and storing executable code effective to cause the one or more processors to:

receive a request from a computing device for requested content, the request referencing a remote server;

retrieve the requested content from the remote server;

render the requested content by a virtual client on a virtual screen;

transmit one or more images of the virtual screen to the computing device;

detect an attempt to access video content referenced in the requested content;

if rendering of the video content in the virtual screen by the virtual client is inferior to delivery of the video content to the computing device according to capabilities of the computing device, invoke streaming of the video content to the first computing device without rendering the video content in the virtual client.

In some embodiments, the virtual client is a web browser and the requested content is a webpage. In some embodiments, the executable code is further effective to cause the one or more processors to evaluate capability of the computing device to display the video content by determining whether the video content has a file type that the computing device is capable of processing.

In some embodiments, the executable code is further effective to cause the one or more processors to evaluate capability of the computing device to display the video content by determining whether the computing device has sufficient memory and processing speed to process the video content.

In some embodiments, the executable code is further effective to cause the one or more processors to evaluate capability of the computing device to display the video content by determining whether the computing device is capable of processing the video content if a network connection to the computing device has sufficient bandwidth to receive the video content.

In some embodiments, the executable code is further effective to cause the one or more processors to invoke streaming of the video content to the computing device without rendering the video content by transmitting an instruction to superimpose display of the video content over the one or more images of the virtual screen on the computing device.

In some embodiments, the attempt to access the video content is intercepted from one of the virtual client and the computing device.

In some embodiments, if the computing device is not capable of processing the video content, one of (a) rendering the video content in the virtual client and (b) reformatting the video content into reformatted content and transmitting the reformatted content to the computing device.

In some embodiments, the executable code is further effective to cause the one or more processors to: if delivery of the video content to the computing device is inferior to rendering of the video content on the content in the virtual client, one of (a) rendering the video content in the virtual client and (b) reformatting the video content into reformatted content and transmitting the reformatted content to the computing device.

### BRIEF DESCRIPTION OF THE DRAWINGS

For purpose of explanation, several embodiments of the invention are set forth in the following figures.

FIG. 1 is a block diagram illustrating a number of embodiments for implementing distributed computing over a network.

FIG. 2 is a flow diagram illustrating an embodiment for implementing distributed computing over a network.

FIG. 3 is a flow diagram illustrating an embodiment for implementing distributed computing over a network.

FIG. 4 is a block diagram illustrating a system to permit computers to remotely share computing resources.

FIG. 5 is a block diagram illustrating one embodiment of a computer architecture to support remote operation of applications for use by one or more computing devices.

FIG. 6 is a flow diagram illustrating one embodiment to initiate a session among multiple users to co-use a software application.

FIG. 7 is a flow diagram illustrating one embodiment for a process for multiple users to co-use an application program.

FIG. 8 is a block diagram illustrating one embodiment for implementing distributed computing and Internet co-browsing among multiple users.

FIG. 9 is a flow diagram illustrating one embodiment for a distributed computing and a co-browsing session.

FIG. 10 is a flow diagram illustrating one embodiment for a distributed computing and a co-browsing process.

FIG. 11 is a block diagram illustrating a system configured to implement distributed computing and the co-use of an application.

FIG. 12 is a flow diagram illustrating one embodiment for implementing a distributed computing and co-browsing session.

FIG. 13 is a block diagram illustrating co-browsing with multiple co-browser instantiations at the virtual server.

FIG. 14 is a diagrammatic representation of a network and a computer system.

### DETAILED DESCRIPTION

The present invention is related to the field of computing, and more specifically to techniques for distributed processing over a network.

The Internet has become an essential medium for business and media. Although use of the Internet in modern society is essentially ubiquitous, one potential area of future expansion in the Internet is the ability for users to share online experiences. Sharing online experiences, such as visiting websites, is one way for users to have a social experience on the Internet. These shared online experiences often take the form of co-browsing. In general, co-browsing is joint navigation of websites by multiple people that access web pages at the same time. Some current techniques for co-browsing require special software at the client and/or co-browsing enabled websites. Since users may only co-browse on web sites that are co-browsing enabled, this technology limits the users to only a small subset of Internet sites. As a consequence, it is desirable to create a co-browsing system that does not require special plug-ins or co-browsing enabled websites so as to permit users to co-browse at any website.

Furthermore, such use of the internet may involve a number of different user devices, in addition to servers and other network components. The devices, servers, and network components may have substantially different capabilities. For example, a tablet computer may have substantially more RAM and storage and a faster CPU than a smart phone. And a device hard-wired to the internet may have substantially better upload and download speeds than a device connected through WiFi, especially at the local café, or a smartphone. Thus, it would be advantageous for applications in general, not just co-browsing applications, to know and modify their use of the various capabilities of the system within which they reside—the environment or “context” within which the application is running or may be directed to work—and maximize or optimize that use for the benefit of the user, i.e., choose the context that is best suited to the application or best suited to process or execute any particular computer operation, such as a request to stream video or manipulate graphics. That is, it would be advantageous to be able to modify an application and/or related processes on a case-by-case basis so that they operate or “live” in an optimized environment.

Co-browsing, as described within as employing a virtual application, is an example of such an application operating within an optimized environment, particularly when compared to screen-sharing. When co-browsing in the virtual application, the browser executes on a virtual server, thus reducing the resources needed from (or data flow from) each participating device to those related mostly to browser input and display functions. This is an example of optimizing the environment. And it may provide a better user experience than systems in which graphical data is uploaded to a proxy and then streamed to guests, as such systems often require gigabytes of data transfer, in contrast to the potential kilobytes needed with this form of distributed computing employing a virtual browser.

Still, there are more processes that can be performed in an optimized environment. For example, it may be advantageous to be able to direct that a CPU-intensive process occurs on a server rather than a smart phone. That is, the user may benefit from an improved experience if a method provided for a system that used network servers for CPU-intensive processing, or processing that required large amounts of RAM, or processing that required large amounts of storage, instead of using the more limited processing power of a local device. And it may be advantageous for a virtual browsing application to direct that a video stream directly from a source to a device, rather than direct that the video stream from the source to the virtual application and then from the virtual application to the device. Such double streaming may result in a degraded or choppy image that impacts the user experience, or delays or interrupts the user experience entirely. In general, responding to a request through a network may result in processes being performed in less-than-ideal computing environments or involve redundancies or inefficiencies in processing or data transmission. Thus, the user may benefit from an improved experience if a method provided for the optimized use of computer capabilities by, e.g., directing the removal of redundancies in data transmission, reception, and processing, directing the re-routing of transmitted data, or directing that certain processing be performed elsewhere.

To achieve such benefits, a computer-implemented method, computer readable medium and system provide for distributed processing. In embodiments, one or more computer devices are connected to a network and a processing manager (or “manager” or “dispatcher”) is instantiated that optimizes the computing environment (or “context”) for a computer process by intercepting network content, modifying the content, and then distributing the modified content. As described within, embodiments using a browser are exemplary and the methods should be understood to apply to computer applications generally.

In an embodiment, the processing manager is instantiated on a server connected to the network. In an embodiment, the processing manager is instantiated on one or more of the computer devices. In embodiments, the processing manager determines the capabilities of: the one or more computer devices involved in a process, and the network which may include one or more connected servers. For example, the processing manager may query the user (or “client”) computer device to determine if the device is a desktop, tablet, or smartphone, and what operating system and browser the computer device is running. With such information the processing manager can make assumptions regarding the capabilities of the computer device, such as that it does not support flash video. Based on such information and assumptions, i.e., the context, the processing manager may direct that a particular process be processed in a different context, be processed in a modified way to adapt the results for the intended recipient, or even not be performed at all. For example, if a computer device does not support flash video, the processing manager may determine to direct that a video not be streamed to the computer device, or that it be transcoded into an acceptable container file format before streaming, e.g., WebM or MP4. In another example, the processing manager may render, or request the rendering of, an image or video on the computer device instead of on the virtual server. Such rendering may be performed if the processing manager determines that it would improve the image quality or delivery speed over streaming the image or video from the virtual browser. In other examples, the processing manager may determine to change file formats or execution contexts, e.g., changing from an initial pdf or flash application to a better-suited alternative.

In an embodiment, the processing manager is an element of a virtual application that allows users to co-browse the network. A host initiates a co-browsing session over a network with a request. The processing manager receives the request and initiates batch processes to instantiate a virtual screen, a virtual browser, and a user interface (UI) server on at least one server. That is, the manager initiates the instantiation of an application program on at least one server so as to run a “virtual browser” on the server. The virtual browser may be used in a co-browsing session with multiple users. The multiple users may employ various computer devices with differing capabilities. The processing manager determines the capabilities of the various computer devices and the network, which may include one or more servers. The processing manager optimizes the context for processing subsequent computer processes for the connected computer devices based on the capabilities of the computer devices, the network, the subsequent computer processes themselves, and the content or data being sent over the network. In an embodiment, computer processes are optimized by the processing manager individually for each connected computer device.

In an embodiment, a processing manager, which is an element of a virtual application that allows users to co-browse the network, optimizes the computing environment by: generating a request from the virtual browser, wherein the request specifies that the output from the network be directed (transmitted) directly to one or more of connected computer devices.

In an embodiment, for a processing manager that is an element of a virtual application that allows users to co-browse the network, optimizing the computing environment includes intercepting a request from the virtual browser to an element of the network, wherein a response to the request would include a transmission to one of the connected computer devices, determining that a part of the response to the request would degrade, delay, or interrupt the user experience if it involved the virtual browser, and directing that the part of the response bypass the virtual browser and be transmitted directly to at least one or more of the connected computer devices.

In an embodiment, a processing manager, which is an element of a virtual application that allows users to co-browse the network, optimizes the computing environment by: intercepting a request from the virtual browser to stream a video from the network to the virtual browser; and directing that the video be streamed directly to one or more of connected computer devices.

In an embodiment, a processing manager, which is an element of a virtual application that allows users to co-browse the network, optimizes the computing environment by: intercepting a request from the virtual browser to transmit non-video content from the network to the virtual browser; and directing that the non-video content be transmitted directly to one or more of connected computer devices.

In an embodiment, a processing manager optimizes the computing environment by: intercepting a request from a computing device; determining that the capabilities of the computing device do not allow the computing device to make use of a part of a response to the request; intercepting the part of the response; and causing it to be modified so that the computing device can make use of it.

In an embodiment, based on the available computing contexts, a processing manager may extract an instruction set and direct that the related processing be performed in a more suitable context than originally intended. For example, an instruction set requiring extensive number crunching could be extracted and performed on a server with the results returned to a smartphone.

In some embodiments, the computer devices may comprise a mobile computing device (e.g., mobile phone, tablet computer, etc.) or a desktop computing device, and the computer devices may vary in capabilities such as CPU speed, RAM, and storage capacity. In some embodiments, the computer devices may be connected directly to the network, or may be wirelessly connected to the network, and the connections may vary in capabilities such as quality and bandwidth. In some embodiments, the network may be connected to one or more servers, the servers having different capabilities. Under these embodiments, the computer devices, and the manner in which they are connected to the network, may result in distinctly different capabilities, including capabilities related to processing, transmitting, receiving, viewing, and storing. The sum of such device capabilities determines the context within which an application may operate on the device.

The embodiments and figures described within this application relate to a computer-implemented method, computer readable medium and system that provide for distributed processing. In embodiments, one or more computer devices are connected to a network and a processing manager application (or “manager” or “dispatcher”) determines the capabilities of the computer devices and network, determines the optimal computing environment for subsequent computer processes and related data or content based on the determined capabilities, and directs that the computer processes be performed in the optimal computing environment.

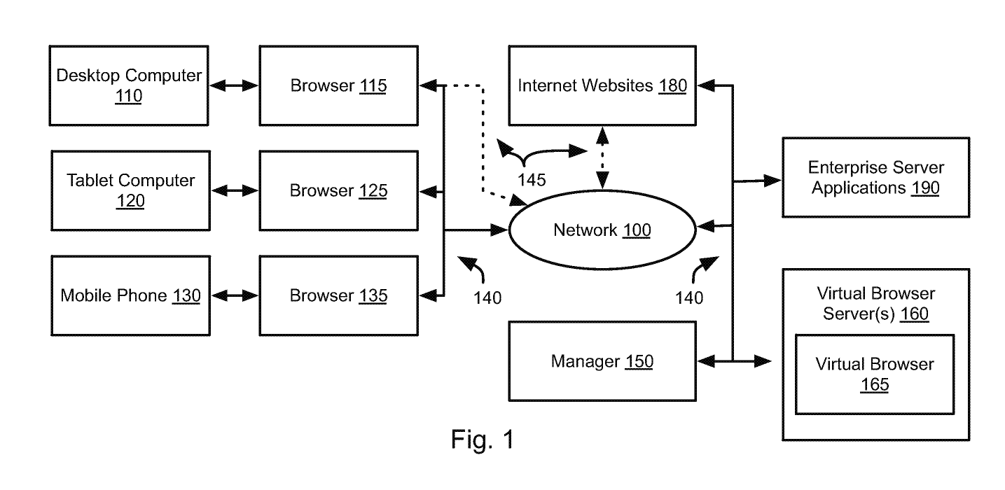

Now regarding the figures and the embodiments, FIG. 1 is a block diagram illustrating a number of embodiments for implementing distributed computing over a network. FIG. 1 depicts network co-browsing and co-using of networked applications. For these embodiments, user computers include a desktop computer 110, a tablet computer 120 and a mobile phone 130, collectively “computer devices.” Computer devices 110, 120, and 130 are running browsers 115, 125, and 135, respectively. Computer devices 110, 120, and 130 connect to a network 100, employing browsers 115, 125, and 135 to interact with network 100. Internet websites 180, enterprise server applications 190, and virtual browser server(s) 160 are also connected to network 100. A virtual browser 165 is running on virtual browser server(s) 160. A processing manager 150 is running on a device connected to network 100. Processing manager 150 may be running on any device connected to network 100, such as any of the devices 110, 120, 130 shown, and any device supporting any of websites 180, applications 190, or virtual browser 165. Network connections 140 generally connect devices 110, 120, and 130, and the servers supporting websites 180, applications 190, and virtual browser server(s) 160, to network 100. Network connections 145 (shown dotted) connect computer 110 and websites 180 to network 100, but are shown dotted to indicate that the path for data transferred between computer 110 and websites 180 does not include virtual browser 165. It should be understood that there are similar dotted connections between websites 180 and devices 120 and 130, and also between devices 110, 120, and 130 and applications 190, to indicate paths that do not include virtual browser 165, but that these similar dotted connections are not shown to avoid undue cluttering in FIG. 1.

Each computer device has different computing resources. For example, desktop computer 110 may have a 15-inch screen, tablet computer 120 may have an 8-inch screen while mobile device 130 has yet an even smaller display. Similarly, desktop computer 110 may have a significantly faster CPU, more RAM, more storage, and a faster network connection than tablet computer 120 or mobile device 130. Similarly, browsers 115, 125, and 135 may have different capabilities, as may the connections between browsers 115, 125, and 135 and network 100. For example, browser 135 running on phone 130 may not support certain video playback software. However, such is not always the case and the examples are given to illustrate that computer devices may have different capabilities.

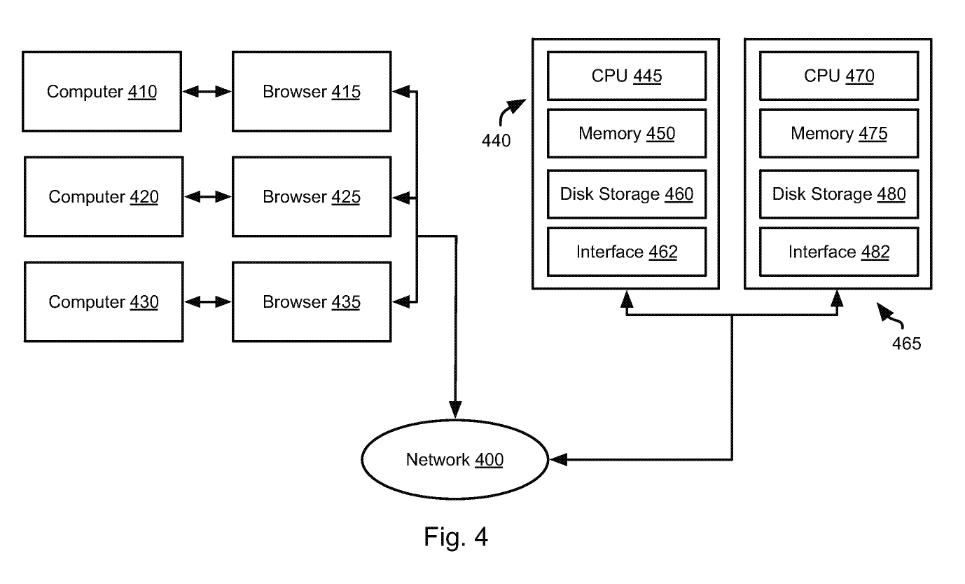

For a first use case shown in FIG. 1, a co-browsing session among devices 110, 120, and 130 has been implemented using virtual browser 165. The implementation of a co-browsing session is described in detail within FIGS. 4-14 and related text. In general, the screen data, rendered on the display of the different computing devices, originates from the virtual browser server (virtual screen). As such, the co-browsing session is not dependent on a format of any computing device of a user (e.g., desktop computer 110, tablet computer 120 or mobile phone 130). In this way, a mobile device 130 may host a web co-browsing session and the screen data from the mobile device, although it originates from a small screen area, is translated by components of the virtual server as described within to an environment appropriate for the larger desktop computer display.

A user of the mobile phone 130 may resize the website response information to view it in a manner appropriate for a mobile device. Since both the desktop computer and a mobile computer see the data of the virtual screen, the mobile phone may resize a portion of the website response information without affecting the size and view of the Website information displayed on the desktop computer. The co-browsing sessions are also not affected by the means at which data is input to the computing devices. For example, a user may click on an image or link using a finger for a tablet computer or mobile device, and click on a link or image through a cursor control device (mouse, electrostatic pad). The input means does not affect co-browsing on the other computing devices. Also, user computer devices may include plug-ins to execute processes and services particularly suitable for the native device. The plug-ins, which enhance the user experience based on the type of computing device, do not affect data seen on other co-browsing user devices. As such, co-browsing is implemented among computers with disparate resources, including different screen sizes, input means and browser configurations.

In FIG. 1, according to an embodiment, a user, via desktop computer 110 and browser 115 may interact with virtual browser 165 and request that the virtual browser stream a video from websites 180 for display on the virtual browser to co-browsing users on computer 120 and phone 130. Processing manager 150 intercepts the request, either before or after the request is received by virtual browser 165, and determines that streaming a video to virtual browser 165 will require that the same video be streamed from virtual browser 165 to each of the co-browsing devices. Processing manager 150 determines that this is not the most optimal use of computing resources as reception and subsequent re-transmission of the video by virtual browser 165 may reduce the quality, speed, or reliability of the retransmitted video. With the information contained in the request that identifies the address of the requested video and the addresses of devices 110, 120, and 130, processing manager 150 may re-route the requested video. Processing manager 150 then modifies the request so that in responding to the request, internet websites 180 stream the requested video directly to each of devices 110, 120, and 130 using pathways 145 to each of devices 110, 120, and 130, which do not include virtual browser 165. Thus, according to the embodiment, the requested video is received and viewed by each device 110, 120, and 130 with the native quality available from the combination of websites 180 and network 100.

In an embodiment, a request is intercepted based on the processing manager's determining the content of the request and determining that the optimal response to the request is to send the requested content directly to the requester and any other designated recipients, bypassing an intermediary such as a virtual browser or the processing manager itself. The processing manager then modifies the request to bypass the intermediaries. In an example of a requested video during a co-browsing session, such a bypass is performed when bypassing the virtual browser will improve the quality, speed, or reliability of the video seen by the users. Such a bypass avoids “double streaming,” i.e., streaming the video to the virtual browser and then streaming the video from the virtual browser to each recipient. However, if the processing manager determines that streaming to the virtual display of the virtual browser is the better choice given the content and the capabilities of the receiving devices and network, i.e., the context, then the request will not be modified. Thus, in an embodiment of distributed processing, the processing manager determines the content of the request, determines which context or contexts are better suited to execute or process the request, and modifies the request so that it is executed accordingly.

In an embodiment the processing manager determines what processes to re-direct to better-suited contexts based on a file format related to the process. For example, the identities and addresses of requested video files or music files are recognizable and parse-able from a network request using video or music-related formats or protocols, such as RTMP, MP4, MP3, or MPG. Similarly Javascript applications can be recognized and, if the processing manager determines that both a virtual browser and the browser running on a user's computer device contain a Javascript engine, the processing manager has the option of whether to direct that the Javascript be processed by the virtual browser or the user's local browser. In determining which is the better context for processing the Javascript, the processing manager may determine whether processing the particular Javascript will be CPU intensive. If so, the processing manager may determine that the better context for processing the Javascript is the virtual browser and its associated Javascript engine. If not, then the processing manager may intercept and modify the request so that the Javascript is processed by the local browser.

In an embodiment, the processing manager is programmed to collapse network requests into a single file. For example, to load a single webpage a guest user may need to load a large number of Javascript files from different servers before being able to view the page. In the embodiment in which multiple guest users request the same webpage, the processing manager collapses such multiple requests into a single file that each guest receives upon requesting the given page. In this way, the processing manager speeds up each user's loading of the webpage because each user, though requesting the same initial large number of files, has had that request modified by the processing manager and as a result receives the same single file. Thus, the initial downloading of the large number of files happens only once—when initially bundled by the processing manager. In this embodiment, the structure of a webpage, the need to download a large number of files to view the webpage, and the number of guest user requests are all factors that are used by the processing manager when determining the best way, or context, for executing the elements of the webpage.

In an embodiment, the processing manager determines the best context for executing a process based on the anticipated elapsed time before obtaining results from the process. For example, should the processing manager recognize a CPU intensive process is destined to be run on a computer device with a relatively slow CPU, i.e., a poor context, the processing manager may direct that the process be performed by a resource with a faster CPU, such as a server, i.e., a better context. In the embodiment, the processing manager may also take into consideration a network speed related to transmitting the results from the server to the computer device. Such information would provide a more complete context than just the CPU speed of the server itself.

In an embodiment, the processing manager is programmed with additional processing rules so that, should the processing manager not recognize a language, protocol, format, or codec, etc., for which it has a specific pre-programmed response, the processing manager may employ the additional processing rules to systematically determine the proper context for the process in question. Thus the additional processing rules may include a method for determining what to intercept and for determining where and how the intercepted content, e.g., a video, is to be allocated, or played, or processed. In an embodiment, the additional processing rules include a video processing algorithm to transcode, re-format, or otherwise process the video to optimize the video for the intended recipient computer device, which may include optimizing for the recipient device's screen size and resolution. For example, if a smart phone cannot process a particular video format, the processing manager may intercept the request and direct that the video be intercepted, written to a file, transcoded to a format that is executable by the smart phone, and then streamed to the requesting smart phone. In an embodiment, such a process is implemented in real-time.

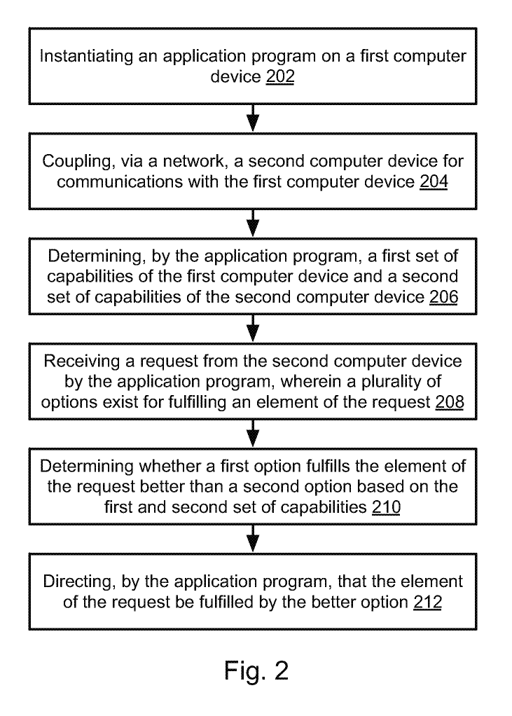

FIG. 2 is a flow diagram illustrating an embodiment for implementing distributed computing over a network. In FIG. 2, at 202, an application program is instantiated on a first computer device. In embodiments, this first computer device may be a server such as virtual browser server(s) 160 (FIG. 1), but it may also be any other computer device, such as computer devices 110, 120, 130 (FIG. 1). At 204, a second computer device is coupled to the first computer device via a network so that the first and second computer devices may communicate with each other. In embodiments, this second computer device may be any of computer devices 110, 120, 130 (FIG. 1). At 206, the application program determines a set of capabilities for the first computer device and a set for the second computer device. In embodiments, the set of capabilities may include, for example: the type of device (smart phone, desktop, server, etc.), the operating system, the browser, the CPU or CPUs and processing speed, the device RAM, the amount of available storage, the type of network connection, the network connection's bandwidth, and what plug-ins are present. At 208, the application program receives a request from the second computer where there exist a number of options for fulfilling a part or element of the request given the computing capabilities of the first and second computer devices. For example, the request may involve CPU and RAM intensive processes, such as those involving graphics, which are more quickly performed by a server than by a smart phone. At 210, based on the capabilities of the system, such as the sets of capabilities of the first and second computer devices, the application program determines which is the better or best of the potential options. And at 212, based on the determination, the application program directs that the part or element of the request be fulfilled according to the better or best of the potential options.

In some embodiments, a computer 110, 120, 130 may host a client application programmed to cooperate with the virtual browser 165. The client application may have dedicated capabilities for receiving updates and other content from the virtual browser. Computers 110, 120, 130 may additionally or alternatively host browsers 115, 125, 135, which each support their own set of video codecs (which may include any of the very many codecs available). In contrast, the client application may bundle support for a number of additional codecs and formats. In some embodiments, the client application would have extra video codecs as well as the ability to play video in place without going full screen, which is a browser limitation on many mobile devices 120, 130. For example, when a user invokes playback of a video in browser in iOS, it automatically fullscreens the video and leaves the webpage. The client application may overcome this restriction and permit overlay of video content on a rendering of a webpage and display simultaneously other user interface and html elements of the webpage with the video playing in any position/size.

Accordingly, the step of evaluating 206 the capabilities of the first computer device may include evaluating whether the first computer device is executing a browser or the client application described above. If the first computer is executing a browser, then processing may be the same as described above with respect to steps 208-212. If the first computer is executing the client application, steps may be taken to improve the video content to the client application thereby taking advantage of the capabilities of the client application. For example, video content may be transcoded to a codec implemented by the client application in order to speed up delivery. The video content may be transmitted to the client application as part of an interface that instructs video content to be overlaid on a rendering of a webpage referencing the video content, where the rendering of the webpage is an image generated by the virtual browser 160 and the video content is either rendered by the virtual browser or streamed directly to the first computer device based on the capabilities of the first computer device as determined using the methods disclosed herein.

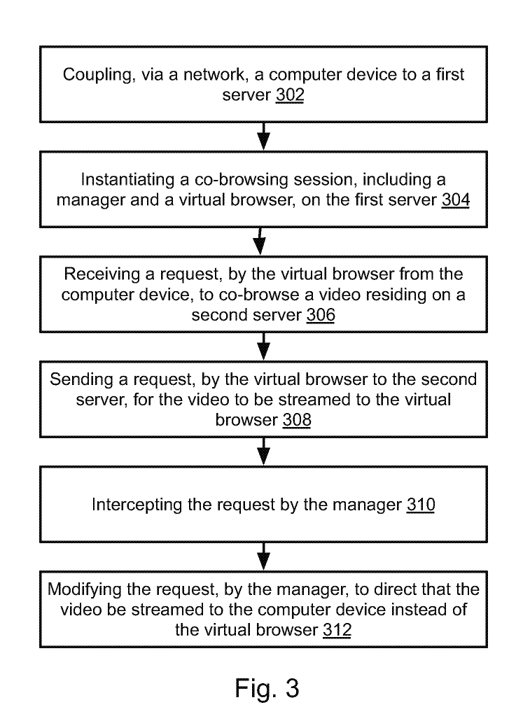

FIG. 3 is a flow diagram illustrating an embodiment for implementing distributed computing over a network in the form of a co-browsing session. Co-browsing sessions are themselves described in more detail regarding FIGS. 4-14, within. In FIG. 3, at step 302, a computer device is coupled to a first server via a network. The computer device may be any of computer devices 110, 120, or 130. At 304, a co-browsing session is instantiated on the first server. The co-browsing session includes a virtual browser and a processing manager. At 306, the computer device requests that the virtual browser co-browse a video that resides on a second server. In embodiments, the video may also reside on the same server on which the virtual browser is instantiated, or on the computer device itself. At 308, the virtual browser sends a request for the video to be streamed to the virtual browser. At 310, the processing manager intercepts the request. In an embodiment, the request is intercepted because the processing manager has been programmed to recognize requests for the streaming of videos. In an embodiment, it is the virtual browser itself that performs the processing manager function. In an embodiment, the virtual browser has been programmed to intercept network requests that relate to certain file formats or protocols, such as RTMP, MP4, MP3, and MPG, and direct that requests for such file formats or protocols be modified according to step 312. At 312, the processing manager modifies the request to request that the video (or a file of a format or protocol described in regard to step 310) be streamed directly from where it resides to the requesting computer device, instead of to the virtual browser. In an embodiment, the processing manager modifies the request based on information it has available regarding the network address of the co-browsing computer device and any other co-browsing computer devices, in addition to information that is contained in the request from the virtual browser, such as the network location of the requested video. As a result, the video is streamed directly to any co-browsing computer devices, thereby bypassing the virtual browser.

In embodiments, bypassing the virtual browser improves the quality of the video seen by the users of the co-browsing computers by eliminating the intervening receiving, processing, and re-streaming of the video by the virtual browser. In such embodiments, each browser running on the co-browsing computer devices shows the video either generally superimposed over the virtual browser window, or superimposed within the virtual browser window as if the virtual browser were streaming the video to the virtual browser window. Superimposing the video without regard to the virtual browser window is, generally, simpler. In either case the user sees a container for the video that results from graphical data sent by the virtual browser. Within the container a “play” button requests playing the video from within the computer device's viewer application, i.e., the host or guest browser requests the streaming of the video directly from YouTube. The resulting video looks native because it is, having bypassed the virtual browser. This example of superimposing video is but one example that illustrates the optimization and improved interact-ability provided by a more general embodiment in which content is transmitted to the host and guest computer devices from both the virtual browser and directly from a different source, such as a network site. The content from both (or multiple) sources is superimposed or otherwise “reconstituted” on the display of the computer device so that all users (host and guests) view or experience the combined content as if it came from one source. That is, the content from the different sources is integrated so that the user experience is “seamless.” An additional example of the embodiment involves transmitting multiple objects, such as images, to user computer devices directly from one or more websites, with the objects being superimposed and scaled to augment or enhance content being transmitted to the same devices from the virtual browser. In an embodiment, virtual browser 165 is programmed to recognize file formats, protocols, containers, and/or codecs within network requests and to intercept and modify such requests so that the response to the request bypasses the virtual browser and is sent directly to any co-browsing computers 110, 120, or 130. In embodiments, requests involving the certain file formats, protocols, containers, or codecs are modified to bypass the virtual browser because it is more efficient for the co-browsing computers to receive and process the response than for the virtual browser to receive and process the response and then re-transmit the response to the co-browsing computers.

FIG. 4 is a block diagram illustrating a system to permit computers to remotely share computing resources. As shown in FIG. 4, computers 410, 420 and 430 access, through network 400, resources on computer (e.g., servers) 440 and 465. Computer servers 440 and 465 include computing resources, such as CPUs (445 and 470), memory (450 and 475) and disk storage (460 and 480). Servers 440 and 465 may be high-end servers with multiple processors, large amounts of memory, and large disk arrays. Conversely, computers 410, 420 and 430 may be computing devices of limited resources, such as mobile devices, tablet devices, or laptop computers. In general, computers 410, 420 and 430 access the servers (440 and 465) to utilize the CPU, memory and disk storage resources. For example, the computers 410, 420 and 430 may interface with servers 440 and 465 to remotely execute application programs that require CPU, memory and disk storage resources. For example, computers 410, 420 and 430 may utilize computer resources on servers 440 and 465 to execute enterprise applications and to browse Internet websites. Embodiments for co-use of applications and co-browsing of Internet Websites by multiple computers are described more fully below.

For the example of FIG. 4, computers 410, 420 and 430 may use computer resources of servers 440 and 465, thereby using only a minimum amount of local computer resources. To this end, computers 410, 420 and 430 operate Internet browsers (415, 425 and 435, respectively). The computers may run any type of Internet browser, such as commercially available browsers Google Chrome, Mozilla Firefox, Microsoft Explorer, etc. In order to provide computer resources, servers 440 and 465 include interface 462 and 482, respectively. Interface 462 and 482 permit communication (exchange of data) between computers (410, 420 and 430) and servers (440 and 465) by using only a browser. To this end, interface 462 and 482 formats all requests and responses between computers (410, 420 and 430) and servers (440 and 465) to the hypertext transfer protocol (HTTP). To accomplish this, interface (462 and 482) converts input/output from the applications running on the server to an HTTP format. Computers 410, 420 and 430 only consume a minimum amount of resources to operate their browsers while utilizing computing resources of servers 440 and 465 to execute software.

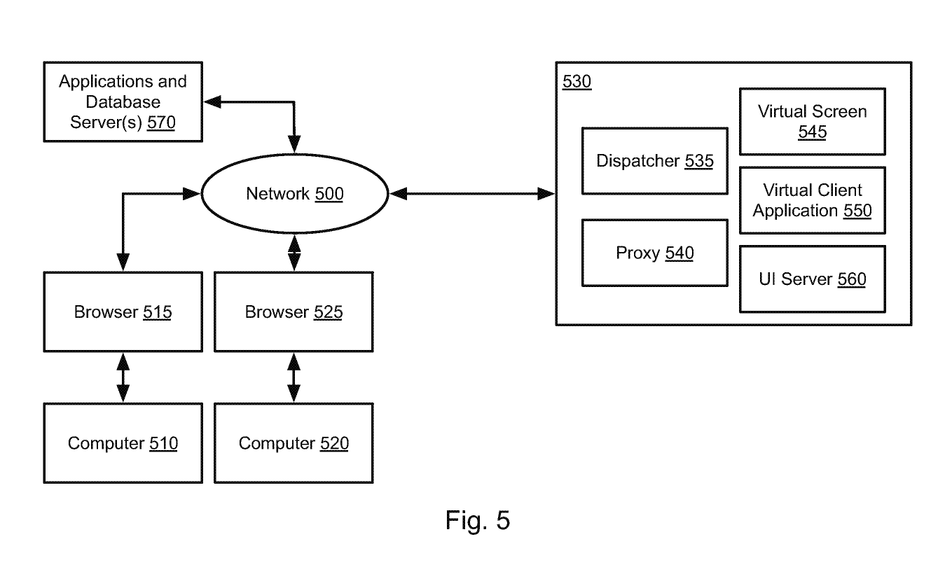

FIG. 5 is a block diagram illustrating one embodiment for a computer architecture to support remote operation of applications for use by one or more computing devices. For this example, software applications, such as enterprise applications, may run on one or more servers. As used herein, an application connotes any software application program that provides functionality. In some embodiments, the applications comprise enterprise applications. As used herein, an enterprise application may include any type of application software that typically runs in an enterprise software environment, including accounting software, customer resource management (CRM) software, enterprise resource planning (ERP) software, etc. For the example of FIG. 5, servers that operate applications, including database servers, are depicted as Applications and Database Server(s) 570. A virtual server 530, which may be implemented on one or more computers, operates to support the remote operation of the application for computers 510 and 520. Applications and Database Servers 570, virtual server 530 and computers 510 and 520 are all accessible through network 500 (e.g., wide area network).

For this example, computers 510 and 520 desire to share use of an application program (e.g., enterprise application) running on Applications and Database Server(s) 570 using browsers 515, 525. As such, computers 510 and 520 “co-use” the enterprise application (i.e., both computers interact with an applications program in a collaborative environment). In some embodiments, the application may run in a client-server environment. For the example of FIG. 5, the server portion of the application program runs on Applications and Database Servers 570, while the client portion runs on virtual server 530 for the benefit of computers 510 and 520.

For this embodiment, the virtual server 530, which may operate on one or more computers, comprises several subcomponents to facilitate the remote operation of the application for the benefit of computers 510 and 520. Specifically, for this embodiment, virtual server 530 includes dispatcher 535. As is explained more fully below, dispatcher 535 initiates a session for multiple users to run enterprise software by instantiating batch processes associated with the session. For this embodiment, the batch processes include virtual screen 545, virtual client application 550 and user interface (UI) server 560. In general, virtual screen 545 stores screen data of the application for viewing on computers 510 and 520. The virtual client application 550 runs the client portion of the application and supplies screen data to virtual screen 545. UI server 560 monitors input data from computers 510 and 520 and updates input to virtual screen 545 and virtual client application 550, as appropriate. UI server 560 may implement processes such as virtual network computing (VNC) or remote desktop protocol (RDP). Proxy 540 operates to connect computers 510 and 520 to the batch processes (i.e., virtual screen 545, virtual client application 550 and UI server 560) instantiated by dispatcher 535. In embodiments, proxy 540 may comprise translation proxy, such as translation proxies 240 (FIG. 2) and 440 (FIG. 4), which connect to their respective computers using WebSocket connections, to obtain the benefits described of such an arrangement.

In operation, virtual client application 550 transmits input data to the server portion of the application (running on Applications and Database Server(s) 570). In turn, the application, running on Applications and Database Server(s) 570, outputs data, including screen data, to virtual client application 550 in a manner typical for operation in a client-server environment. Virtual server 530 transmits screen data to, and receives input data from, computers 510 and 520 via an Internet protocol.

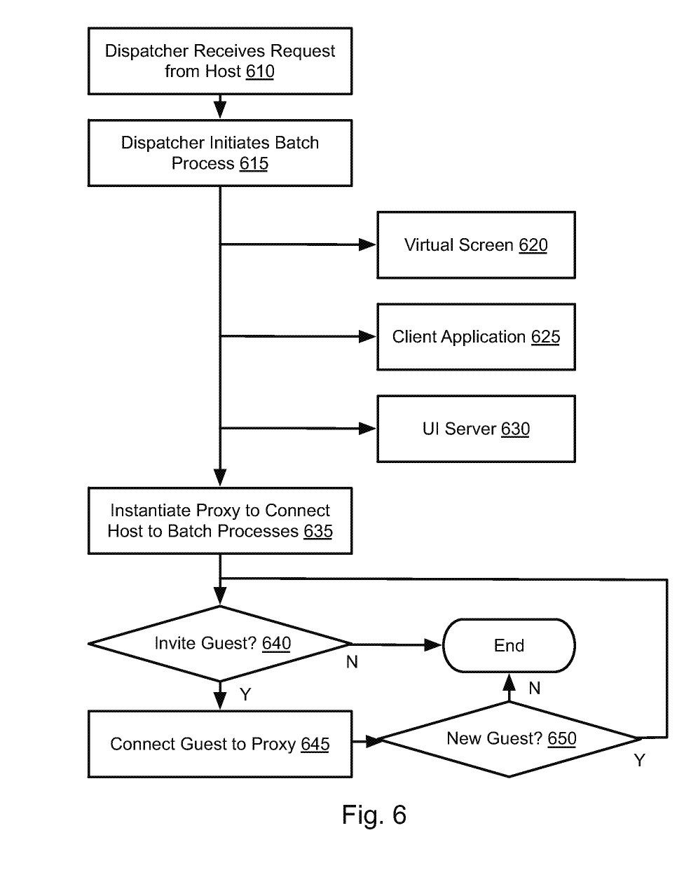

FIG. 6 is a flow diagram illustrating one embodiment to initiate a session among multiple users to co-use a software application. In some embodiments, the system designates a host to initiate the co-use session with the application software. Then, the host invites one or more guests to “co-use” the resources of the software application. The process begins as the dispatcher receives a request from a host to initiate a session with the application (block 610, FIG. 6). In response to the request, the dispatcher initiates 635 the batch processes (block 615, FIG. 6) to instantiate the virtual screen (620), client application (625) and UI server (630). Then, a proxy, which connects the host to the batch processes, is instantiated. The host may then invite one or more guests, and the guests are connected to the proxy (which connects the guests to the batch process services) (blocks 640 and 645, FIG. 6). If the host desires to add a new guest, then the process is repeated and subsequently the new user is connected to the proxy so as to gain access to the batch process services (blocks 650, 640 and 645, FIG. 6). If all guests have been connected to the batch process service, then the initialization is complete.

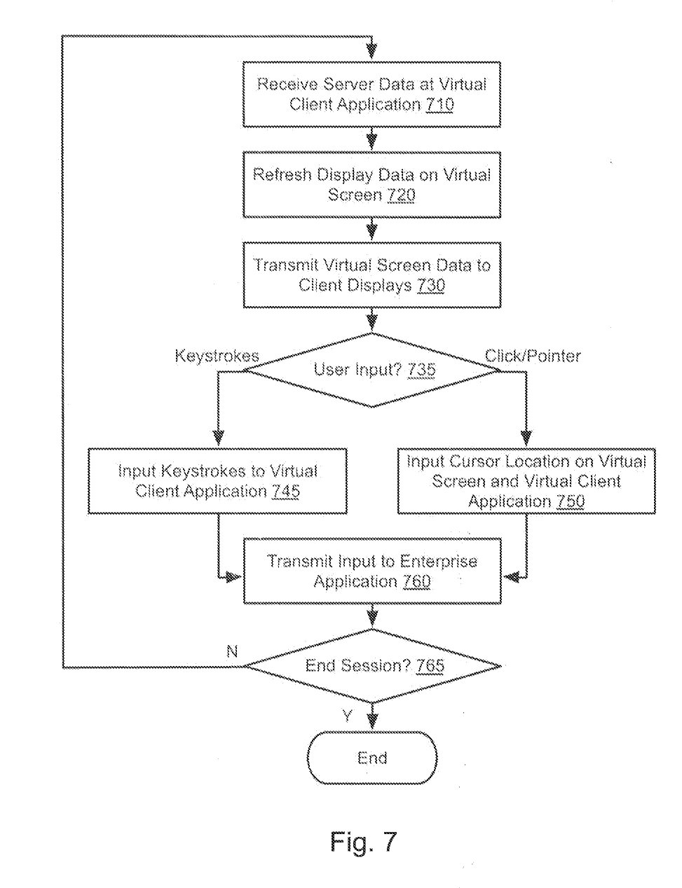

FIG. 7 is a flow diagram illustrating one embodiment for a process for multiple users to co-use an application program. As described above, the application may run on one or more remote servers, and the virtual client application forms a client-server environment with the application and database server(s). For this embodiment, the process begins when the virtual client application, running on the virtual server, receives data from the application (block 710, FIG. 7). For example, the application may comprise a login screen to facilitate a user, such as the host, to log-on to the application. In response to receiving the data at the virtual application, the display data is refreshed on the virtual screen (block 720, FIG. 7). For example, if the application transmits a logon screen, then a rendition of the logon screen is rendered on the virtual screen on the virtual server. The updated virtual screen data is then transmitted to the user computers for rendering on the various client displays (block 730, FIG. 7). For example, if one user computer consists of a mobile device, then the application logon screen is rendered on the display of the mobile device. Similarly, if the user computer device consists of a desktop computer, with a high-resolution output display, the logon screen for the application software is rendered on the high-resolution output display. Then, the process waits for input from the user computers (block 735, FIG. 7). If the system server receives, from one or more user computers, keystrokes, then the keystrokes are input to the virtual client application (block 745, FIG. 7). If the user computer inputs a click, along with cursor position information, then the input cursor location and click are updated on the virtual screen and input to the virtual client application (blocks 735 and 750, FIG. 7). In one embodiment, the UI server monitors keystroke, click and cursor position from the user computers to perform these functions. The input data (keystroke, click and cursor position) from the user computers is transmitted to the application from the virtual client application (block 760, FIG. 7). This process, which includes receiving data from the application, transmitting screen data to the user computers, receiving input data from the user computers, and subsequently inputting data to the application, is repeated until users desire to end the session with the application is detected 765.

The application co-use techniques disclosed herein support use cases for training and service of applications software. For example, a host may co-use an application to train a guest in learning to use the application. Under this use case scenario, a host may conduct transactions with the application through the virtual server. Then, a guest may interact with the application software without requiring the host to relinquish control to the guest. In contrast, in a screen sharing application, the host computer transfers control to the guest computer in order to permit the guest computer to conduct transactions with the application. As such, the application co-use techniques disclosed herein support co-using applications between users without requiring transfer of control or host screens. The application co-use techniques disclosed herein support use cases that effectively require switching control between users such that both co-users input data to the application. As such, application co-use techniques disclosed herein provide an environment for true collaboration because users are not required to execute functions in order to transfer the ability for each co-user to input data into the application.

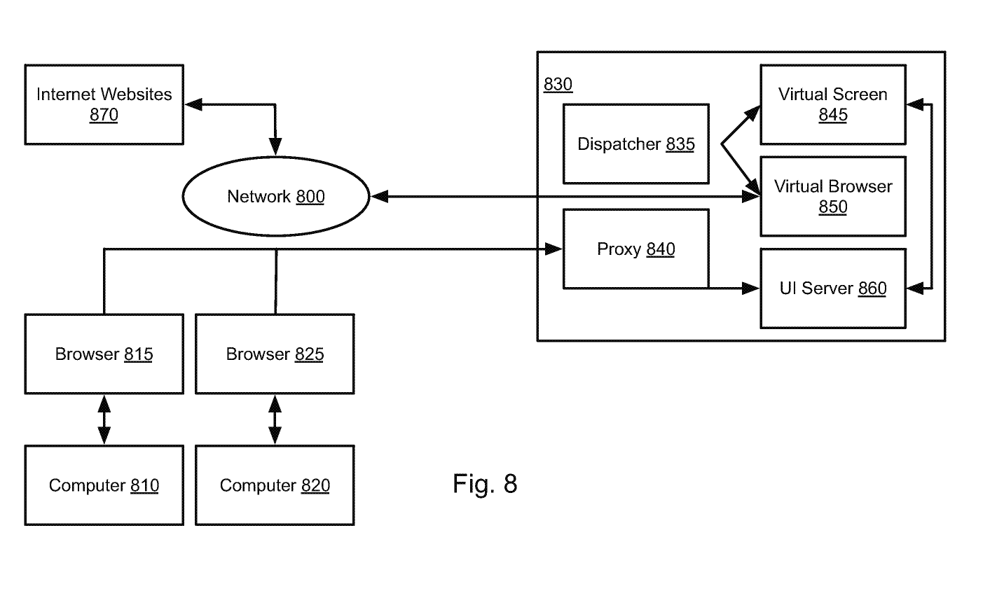

FIG. 8 is a block diagram illustrating an embodiment of a system configured to initiate the co-use of a virtual application. To illustrate the co-use of an application, this example describes a co-browsing session. Dispatcher 835 receives a request from browser 815 or 825 to begin Web browsing sessions and, in turn, initiates, as a batch process, virtual screen 845, virtual browser 850, UI server 860, and proxy 840 processes. Dispatcher 835 may also be called a “manager” or “process manager.” After a session has been started, computers 810 and 820 access the batch processes through proxy 840. In conducting a co-browsing session, users, from computers 810 and 820, operating through their respective browsers (815 and 825), access a virtual browser 850 on virtual server 830 via network 800 (virtual server 830 should be understood to be connected to computers 810 and 820 through network 800, though the connections are not shown in FIG. 8). The virtual browser 850 operates to access Internet websites 870 through network 800. The virtual screen 845 stores screen data for replication to computers 810 and 820. UI server 860 monitors incoming data from browsers (815 and 825) of computers (810 and 820) and inputs the incoming data to virtual screen 845 and UI server 860. UI server 860 may run communication protocols, such as virtual network computing (VNC), or remote desktop protocol (RDP).

In operation, users, through computers 810 and 820, access Websites (Internet websites 870). Users enter website information into their respective browsers (815 and 825). This website information is input to the virtual browser 850 by way of proxy 840, UI server 860, and virtual screen 845. Virtual browser 850, operating like browser 815 and 825, accesses the Internet websites through a standard HTTP TCP/IP protocol. Virtual browser 850 transmits the website information, input by the users, to the Internet websites 870, and retrieves website response data returned by the Website. The response data is transferred to the virtual screen 845, and subsequently transmitted to computers 810 and 812, through browsers, for display at computers 810 and 812.

As the sessions are co-browsing, any user (user of computer 810 or user computer 820) may input information (keystrokes, clicks and cursor position), and the input information is both displayed on the virtual screen and interpreted for a web request to the Internet websites 870. In some embodiments, the co-browsing session designates a host and one or more guests. For this embodiment, the host may initiate a co-browsing session with one or more guests.

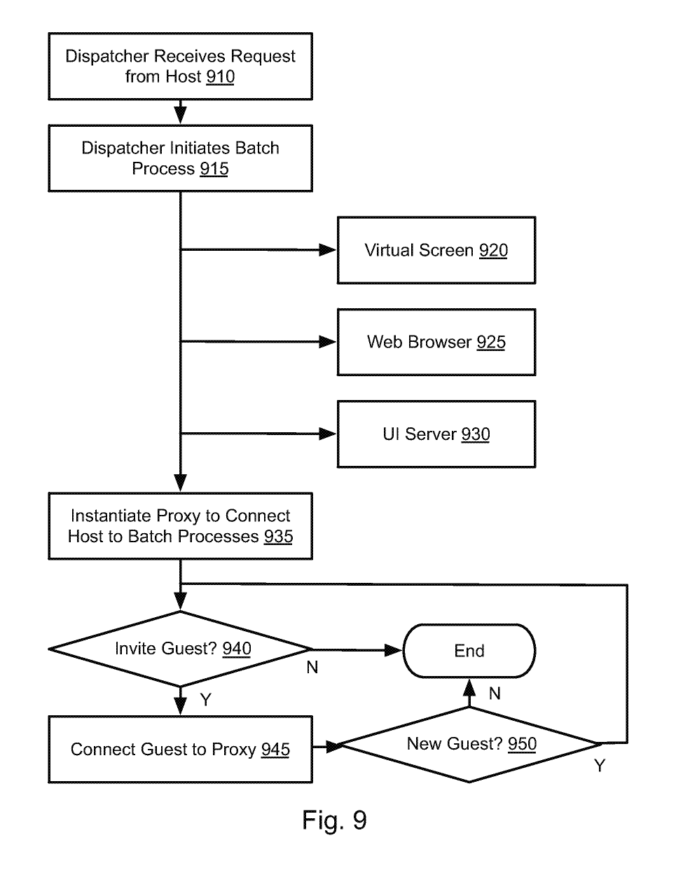

FIG. 9 is a flow diagram illustrating one embodiment for initiating a co-browsing session. The dispatcher receives a request from a host to initiate a web browsing session (block 910, FIG. 9). In response to the request, the dispatcher initiates batch processes (block 915, FIG. 9) that include virtual screen (block 920), virtual web browser (block 925) and UI server (block 930). Then, a proxy is instantiated to connect the host computer to the initiated batch processes (block 935). The host user is now connected for a web browsing session. To add one or more guests, the host, in some predetermined protocol, may invite a guest (block 940, FIG. 9). To add a guest, the guest connects to the batch processes via a proxy. Similarly, additional guests for the co-browsing session may be entered (block 950, 940 and 945, FIG. 9).

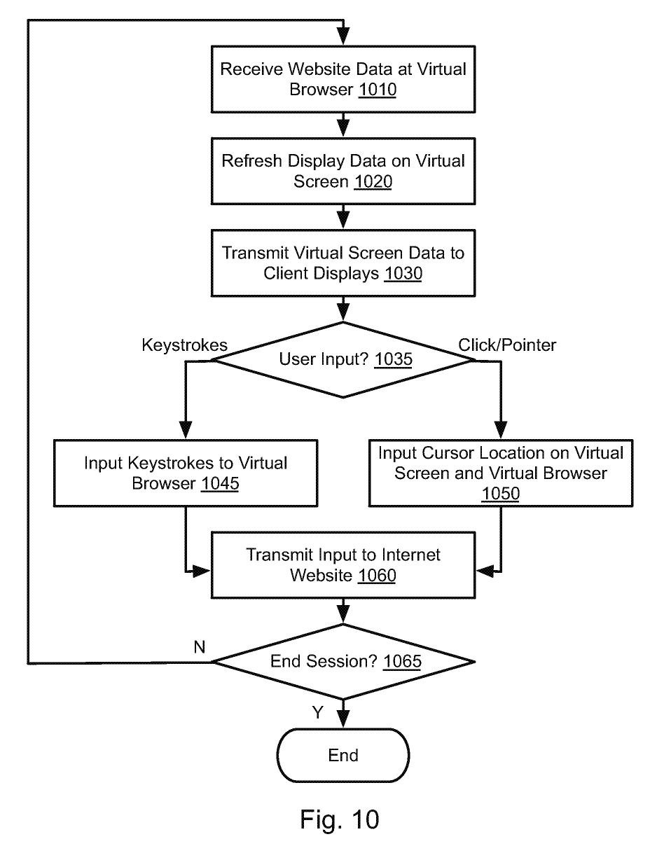

FIG. 10 is a flow diagram illustrating one embodiment for a co-browsing process. Initially, a user sends web information to access a Website of interest. The web information is received at the virtual browser (block 1010, FIG. 10). The display screen on the virtual screen is refreshed (block 1020, FIG. 10). The virtual screen data is transmitted, over the network, for display on the user computers. The requests, including the web information and output from the user computers, are monitored to detect a user operation (i.e., input keystroke, clicks, and cursor position). If the user inputs keystrokes, then the keystrokes are input to the virtual browser, as appropriate (block 1045, FIG. 10). If the user inputs clicks and cursor position, the input cursor location is input to the virtual screen and the virtual browser (blocks 1035 and 1050, FIG. 10). In response to the input data, the virtual browser transmits the web information to Internet websites (block 1060, FIG. 10). The steps for the user to request web information from the user device and subsequently retrieve response information from the virtual server and Internet websites are repeated for each request and response cycle (blocks 1010, 1020, 1030, 1035, 1045, 1050, 1060) until the user ends 1065 the session.

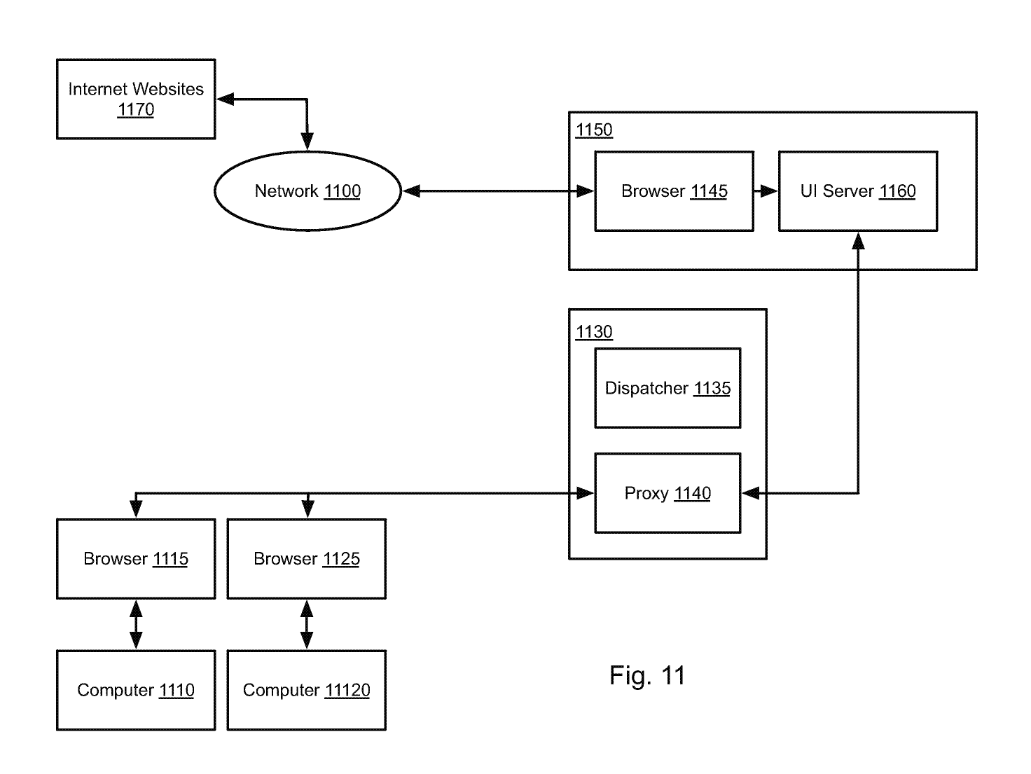

FIG. 11 is a block diagram illustrating a system configured to initiate the co-use of an application. To illustrate the co-use of an application, this example describes a co-browsing session. Requests to begin Web co-browsing sessions may be initiated by any users as discussed previously, but in this example a request is initiated by the user of computer 1150. Dispatcher 1135 receives requests to begin Web co-browsing sessions and, in turn, initiates, as a batch process, UI server 1160, and proxy 1140 processes. Dispatcher 1135 may also be called a “manager” or “process manager.” UI server 1160 is instantiated on computer 1150 and proxy 1140 is instantiated on virtual server 1130. In conducting a co-browsing session, users, from computers 1110 and 1120, operating through their respective browsers (1115 and 1125), access a browser 1145 on computer 1150 via virtual server 1130 and network 1100 (virtual server 1130 should be understood to be connected to computers 1110 and 1120 through network 1100, though the connections are not shown in FIG. 11). Browser 1145 operates to access Internet websites 1170 through network 1100. UI server 1160 on computer 1150 and monitors incoming data from browsers (1115 and 1125) of computers (1110 and 1120) and inputs the incoming data to browser 1145. UI server 1160 monitors screen data from browser 1145 and user input from computer 1150 and transmits the screen data and user input to browsers 1115 and 1125. UI server 1160 may employ, for example, processes for communications, such as virtual network computing (VNC), or remote desktop protocol (RDP). Dispatcher 1135 receives requests to begin Web co-browsing sessions and, in turn, initiates, as a batch process, UI server 1160, and proxy 1140 processes. Dispatcher 1135 may also be called a “manager” or “process manager.” In some embodiments, proxy 1140 is instantiated within the same private network as UI server 1160. In some embodiments, the UI server 1160 may communicate directly with computers 1110 and 1120.

In operation, users, through computers 1110 and 1120, access Websites (Internet websites 1170). Users enter website information into their respective browsers (1115 and 1125). This website information is input to browser 1145 by way of proxy 1140 and UI server 1160. Browser 1145 accesses internet websites 1170 through a standard HTTP TCP/IP protocol. Browser 1145 transmits the website information, input by the users, to internet websites 1170, and retrieves website response data returned by the Website. The response data is transmitted to computers 1110 and 1112, through UI server 1160, proxy 1140, and browsers 1115 and 1125, for display at computers 1110 and 1112.

As the sessions are co-browsing, any user (user of computer 1110 or user computer 1120 or user of computer 1150) may input information (keystrokes, clicks and cursor position), and the input information is both displayed on computers 1150, 1110, and 1120, and interpreted for a web request to the Internet websites 1170. In some embodiments, the co-browsing session designates computer 1150 as a host and computers 1110 and 1120 as guests. In this example, the host computer 1150 has initiated the co-browsing session with guest computers 1110 and 1120.

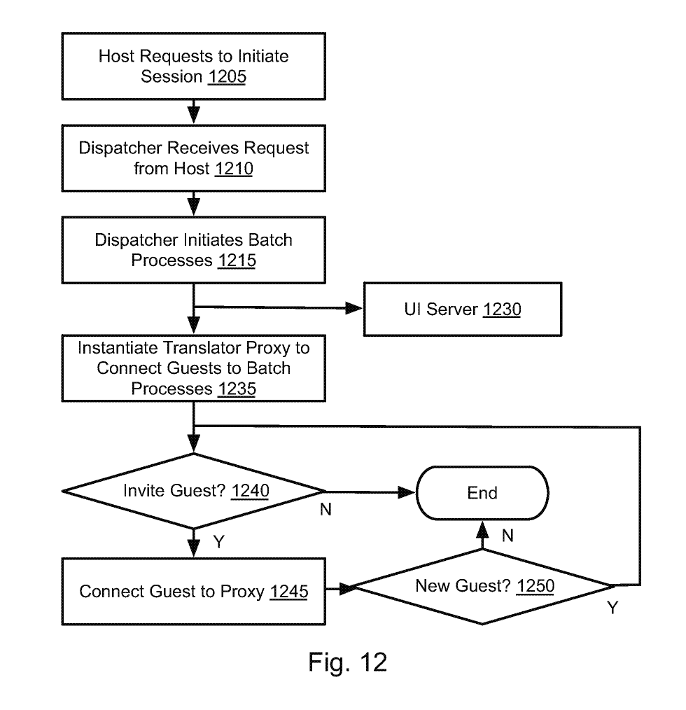

FIG. 12 is a flow diagram illustrating one embodiment for initiating a co-browsing session. A host initiates the co-browsing session (block 1205). The dispatcher 1135 (FIG. 11) receives a request from the host to initiate a web browsing session (block 1210). In response to the request, the dispatcher initiates batch processes (block 1215) that include a UI server (block 1230). Then, a proxy is instantiated to connect the host and subsequent invited guest computers to the initiated batch processes (block 1235). To add one or more guests, the host, in some predetermined protocol, may invite a guest (block 1240). To add a guest, the guest connects to the batch processes via a proxy, translator or otherwise (block 1245). Similarly, additional guests for the co-browsing session may be entered (block 1250, 1240 and 1245). As discussed above, the dispatcher (or “processing manager” or “manager”) may also optimize the computing environment (or “context”) for a computer process by, for example, directing that CPU-intensive processes be performed on a server, or intercepting network content, modifying the content, and then distributing the modified content. Furthermore, the dispatcher may optimize the computing environment by: intercepting a request from the virtual browser that output from the network be transmitted to the virtual browser; and directing that the output be transmitted directly to one or more of connected computer devices.

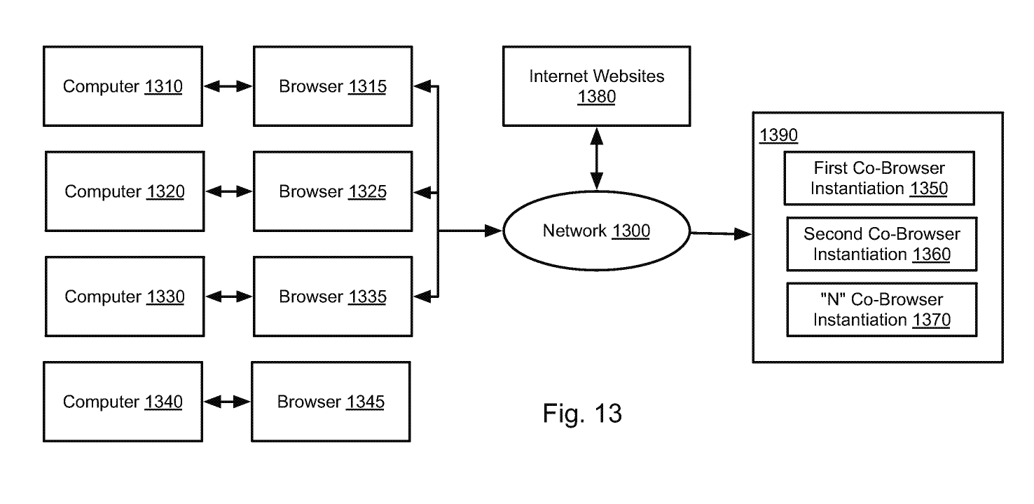

FIG. 13 is a block diagram illustrating co-browsing with multiple co-browser instantiations at the virtual server. As shown in FIG. 13, virtual server 1390 supports multiple co-browsing sessions simultaneously over a network 1300. In this way, any user on a computing device (computer 1310, 1320, 1330 and 1340) connected to the virtual server 1345 over the network 1300 may enter into one or more co-browsing sessions with another user through a browser (e.g., browser 1315, 1325, 1335, or 1345). For example, computer 1310, through browser 1315, may enter into a first co-browsing session with user of computer 1320. In the first co-browsing session, data is generated (i.e., cookie data collected from websites 1380 visited over the network 1300). Co-browsing data for the first co-browsing session may be stored in the first co-browser instantiation 1350. A second co-browsing session, supported by a second co-browser instantiation 1360, may include a browsing session with computers 1330 and 1340. Similarly, any combination of any user computers may enter into a co-browsing session to create any number of “N” co-browsing sessions. For example, computer 1310, although in a co-browsing session with computer 1320, may enter into a couple browsing session with computer 1330 or 1340.

Typically, in a co-browsing session, cookies are shared among the computers co-browsing. In the co-browsing techniques disclosed herein, session data (cookies) are not shared. All session data remains at the virtual server (on the virtual browser). As such, the co-browsing techniques disclosed herein provide a secure co-browsing environment for the user computers.

The co-browsing techniques disclosed herein support saving and securing session data for different sessions. In one use case, a host may wish to start several different sessions with different users. For sample, a host of a virtual shopping experience may start a co-browsing session with multiple users. For the example configuration shown in FIG. 13, the host user may use computer 1310 and browser 1315. The guest users, in this example, may use computers 1320, 1330 and 1340. The host computer 1310 may co-browse with computer users 1320, 1330 and 1340, to create session data in the first co-browser instantiation (1350). Then, the host user (computer 1310) may desire to create a second co-browser instantiation 1360 to conduct a one-on-one session between host computer 1310 and guest computer 1320. During co-browsing in this second co-browsing session, all session data is stored within the second co-browser instantiation 1360. In this matter, any number of sessions may be created and the co-browsing data, collected during the session, may be secured and stored. It this way, a co-browsing session may be continued in the future by using session data from a prior co-browsing session.

The co-browsing architecture disclosed herein supports the ability to co-browse among all Internet websites. Using these embodiments, websites do not require special Java enabled scripts for execution in a user computer browser. One application for co-browsing is the creation of a virtual party with multiple browsers. In one use case, a host may provide a shopping experience for one or more guests. The host may want to navigate to different websites and present different products and services to the guests. Using the co-browsing techniques described herein, the host may shop at any retailer website without restriction to only shopping at co-browser enabled websites. Similarly, a co-browsing session may be used to plan travel among one or more friends arranging a trip. Again, the co-browsing users may navigate to any website without restrictions as to whether the website is browser enabled. Since the co-browsing session to organize a trip would potentially include many different types of websites (e.g., websites for transportation, hotels, entertainment, etc.), the co-browsing techniques described herein support use cases where the co-browsing session includes many different types of websites.

Computer & Network System

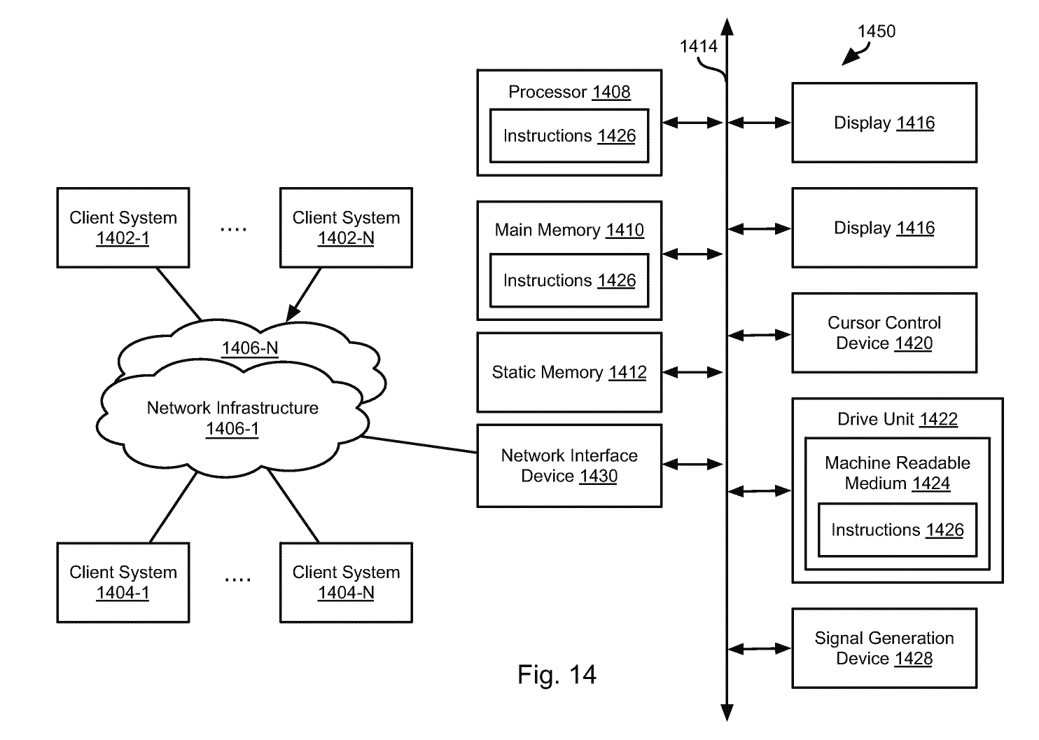

FIG. 14 is a diagrammatic representation of a network 1400, including nodes for client computer systems 1402-1 through 1402-N, nodes for server computer systems 1404-1 through 1404-N, nodes for network infrastructure 1406-1 through 1406-N, any of which nodes may comprise a machine 1450 within which a set of instructions for causing the machine to perform any one of the techniques discussed above may be executed. The embodiment shown is purely exemplary, and might be implemented in the context of one or more of the figures herein.

Any node of the network 1400 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1450 includes a processor 1408 (e.g. a processor core, a microprocessor, a computing device, etc.), a main memory 1410 and a static memory 1412, which communicate with each other via a bus 1414. The machine 1450 may further include a display unit 1416 that may comprise a touch-screen, or a liquid crystal display (LCD), or a light emitting diode (LED) display, or a cathode ray tube (CRT). As shown, the computer system 1450 also includes a human input/output (I/O) device 1418 (e.g. a keyboard, an alphanumeric keypad, etc.), a pointing device 1420 (e.g. a mouse, a touch screen, etc.), a drive unit 1422 (e.g. a disk drive unit, a CD/DVD drive, a tangible computer readable removable media drive, an SSD storage device, etc.), a signal generation device 1428 (e.g. a speaker, an audio output, etc.), and a network interface device 1430 (e.g. an Ethernet interface, a wired network interface, a wireless network interface, a propagated signal interface, etc.).

The drive unit 1422 includes a machine-readable medium 1424 on which is stored a set of instructions (i.e. software, firmware, middleware, etc.) 1426 embodying any one, or all, of the methodologies described above. The set of instructions 1426 is also shown to reside, completely or at least partially, within the main memory 1410 and/or within the processor 1408. The set of instructions 1426 may further be transmitted or received via the network interface device 1430 over the network bus 1414.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

Although the present invention has been described in terms of specific exemplary embodiments, it will be appreciated that various modifications and alterations might be made by those skilled in the art without departing from the spirit and scope of the invention.

What is claimed is:

1. A computer-implemented method for distributed computing, comprising:
instantiating, on a first computer device comprising at least one processor and memory, an application program;
coupling, via a network, a second computer device for communications with the first computer device;
determining, by the application program, a first set of capabilities of the first computer device and a second set of capabilities of the second computer device;
receiving a request from the second computer device by the application program, wherein a plurality of options exist for fulfilling an element of the request;
determining whether a first option fulfills the element of the request better than a second option based on the first and second sets of capabilities; and
directing, by the application program, that the element of the request be fulfilled by the better option.

2. The computer-implemented method of claim 1, wherein the first computer device comprises a first server, wherein a second server is connected to the first server and to the second computer device via the network, wherein the request comprises a request to view a video stored on the second server, wherein the element of the request comprises streaming the video from the second server, wherein the first option comprises streaming the video directly to the second computer device via the network, wherein the second option comprises streaming the video to a virtual browser instantiated on the first server and streaming the video from the virtual browser to the second computer, and wherein the application program directs that the element of the request be fulfilled by the first option.

3. The method of claim 2, wherein the application program contains instructions to direct, when the element of the request comprises streaming the video from the second server, that the video be streamed directly to the second computer.

4. A computer-implemented method for distributed computing, comprising:
receiving, by a server system from a first computing device, a request for requested content from a remote server;
retrieving, by the server system, the requested content from the remote server;
rendering, by the server system, an image in a virtual client by processing the requested content;
transmitting, by the server system, the image to the first computing device;
detecting, by the server system, an attempt to access video content referenced in the requested content;
determining, by the server system, that the first computing device is capable of processing the video content; and
in response to determining that the first computing device is capable of processing the video content, invoking streaming of the video content to the first computing device without rendering the video content in the virtual client.

5. The computer implemented method of claim 4, wherein the virtual client is a web browser and the requested content is a webpage.

6. The computer implemented method of claim 4, wherein determining that the first computing device is capable of processing the video content comprises determining that the video content has a file type that the first computing device is capable of processing.

7. The computer implemented method of claim 4, wherein determining that the first computing device is capable of processing the video content comprises determining that the first computing device has sufficient memory and processing speed to process the video content.

8. The computer implemented method of claim 4, wherein determining that the first computing device is capable of processing the video content comprises determining that a network connection to the first computing device has sufficient bandwidth to receive the video content.

9. The computer implemented method of claim 4, wherein determining that the first computing device is capable of processing the video content comprises determining that an operating system of the first computing device indicates capacity to process the video content.

10. The computer implemented method of claim 4, wherein determining that the first computing device is capable of processing the video content comprises determining that the first computing device is hosting an application programmed to interoperate with the virtual client, the computer implemented method further comprising:
formatting the video content for rendering by the application at least one of (a) using a codec of the application and (b) superimposed over a portion of the image such that other interface elements of the requested content are visible on the first computing device while the video content is displayed.

11. The computer implemented method of claim 4, invoking streaming of the video content to the first computing device without rendering the video content in the virtual client comprises transmitting an instruction to superimpose display of the video content over the image on the first computing device.

12. The computer implemented method of claim 4, wherein the attempt to access the video content is intercepted from the virtual client.

13. The computer implemented method of claim 4, wherein the attempt to access the video content is intercepted from the first computing device.

14. The computer implemented method of claim 4, further comprising:
receiving, by the server system from a second computing device, a second request for second requested content from a second remote server;
retrieving, by the server system, the second requested content from the second remote server;
rendering, by the server system, a second image in the virtual client by processing the second requested content;
transmitting, by the server system, the second image to the second computing device;
detecting, by the server system, an attempt to access second video content referenced in the second requested content;
determining, by the server system, that the second computing device is not capable of processing the video content;
in response to determining that the second computing device is not capable of processing the video content, reformatting the video content into reformatted video content and transmitting the reformatted video content to the second computing device.

15. The computer implemented method of claim 4, further comprising:
receiving, by the server system from a second computing device, a second request for second requested content from a second remote server;
retrieving, by the server system, the second requested content from the second remote server;
rendering, by the server system, a second image in the virtual client by processing the second requested content;
transmitting, by the server system, the second image to the second computing device;
detecting, by the server system, a second video request from the second computing device for second video content referenced in the second requested content;
determining, by the server system, that the second computing device is not capable of processing the video content;
in response to determining that the second computing device is not capable of processing the video content, rendering the video content in the virtual client and transmitting the rendering of the video content to the second computing device.

16. A system comprising one or more processors and one or more memory devices coupled to the one or more processors and storing executable code effective to cause the one or more processors to:
receive a request from a computing device for requested content, the request referencing a remote server;
retrieve the requested content from the remote server;
render the requested content by a virtual client on a virtual screen;
transmit one or more images of the virtual screen to the computing device;
detect an attempt to access video content referenced in the requested content;
if rendering of the video content in the virtual screen by the virtual client is inferior to delivery of the video content to the computing device according to capabilities of the computing device, invoke streaming of the video content to the first computing device without rendering the video content in the virtual client.

17. The system of claim 16, wherein the virtual client is a web browser and the requested content is a webpage.

18. The system of claim 16, wherein the executable code is further effective to cause the one or more processors to evaluate capability of the computing device to display the video content by determining whether the video content has a file type that the computing device is capable of processing.

19. The system of claim 16, wherein the executable code is further effective to cause the one or more processors to evaluate capability of the computing device to display the video content by determining whether sufficient memory and processing speed to process the video content.

20. The system of claim 16, wherein the executable code is further effective to cause the one or more processors to evaluate capability of the computing device to display the video content by determining whether a network connection to the computing device has sufficient bandwidth to receive the video content.

21. The system of claim 16, wherein the executable code is further effective to cause the one or more processors to evaluate capability of the computing device to display the video content by determining whether an operating system of the first computing device indicates capacity to process the video content.

22. The system of claim 16, wherein the executable code is further effective to cause the one or more processors to invoke streaming of the video content to the computing device without rendering the video content by transmitting an instruction to superimpose display of the video content over the one or more images of the virtual screen on the computing device.

23. The system of claim 16, wherein the executable code is further effective to cause the one or more processors to:
if delivery of the video content to the computing device is inferior to rendering of the video content on the content in the virtual client, one of (a) rendering the video content in the virtual client and (b) reformatting the video content into reformatted content and transmitting the reformatted content to the computing device.
